(19) United States
(12) Patent Application Publication
(10) Pub. No.: US 2018/0356900 A1
(43) Pub. Date: Dec. 13, 2018

(54) MOUSE

(71) Applicant: Primax Electronics Ltd., Taipei (TW)

(72) Inventors: Shao-Lun Hsiao, Taipei (TW); Chia-Yuan Chang, Taipei (TW); Chun-Lin Chu, Taipei (TW)

(21) Appl. No.: 15/812,669

(22) Filed: Nov. 14, 2017

(30) Foreign Application Priority Data
Jun. 9, 2017 (TW) 106119280

(51) Int. Cl. G06F 3/038; G06F 3/0354; G06F 3/0362

(52) U.S. Cl. CPC G06F 3/038; G06F 3/0362; G06F 3/03543

(57) ABSTRACT

The present invention provides a mouse, including a mouse body, a button input component, and an idle stroke eliminating part. The button input component includes a button sensing element and a pressing member. The button sensing element is installed in the mouse body. The pressing member covers the outside of the mouse body, and the pressing member includes a connecting pole, where the connecting pole is inserted into the mouse body to abut against the button sensing element. The idle stroke eliminating part is disposed outside the mouse body, and the idle stroke eliminating part includes a pivot and an interference member. The pivot is pivotally connected to the mouse body; and the interference member is crimped on an upper surface of the mouse body, so that an idle stroke is eliminated.

### FIELD OF THE INVENTION

The present invention relates to a mouse.

### BACKGROUND OF THE INVENTION

A mouse is a common fitting of a computer device. Electronic data in a computer screen is operated or edited mainly by sliding the mouse to move a cursor in the computer screen together with pressing buttons of the mouse or rolling a scroll wheel.

A common mouse mainly includes an enclosure, a pair of pressing members, a pair of button sensors, a scroll wheel, an encoder, a circuit board, and a controller. The circuit board, the controller, the encoder, and each button sensor are separately installed in the enclosure. The encoder and each button sensor are separately and electrically connected to the circuit board and the controller. The controller is also electrically connected to the circuit board. Each pressing member covers the outside the enclosure and is extended with a connecting pole. A part of each connecting pole that is inserted into the enclosure abuts against a corresponding button sensor. The scroll wheel is installed between the pair of pressing members and is connected to the encoder.

However, the pressing member of a common mouse is usually plastic, and the pressing member is usually made by means of injection modeling. Therefore, the pressing member will compress after the injection modeling, resulting in pressing member deformation and that the connecting pole fails to abut against the button sensor, and causing an idle stroke between the connecting pole and the button sensor. In addition, when the mouse has been used for a period of time, the pressing member may easily get deformed for the sake of elastic fatigue, and the connecting pole fails to abut against the button sensor, causing an idle stroke between the connecting pole and the button sensor. Therefore, when the connecting pole fails to abut against the button sensor, a hand feeling while using the mouse and sensitivity of pressing the pressing member to operate the mouse are affected. The foregoing situation is urgent to be improved.

### SUMMARY OF THE INVENTION

A main objective of the present invention is to provide a mouse.

In a preferred embodiment, the present invention provides a mouse, including a mouse body, a button input component, and at least one idle stroke eliminating part. The button input component includes at least one button sensing element and at least one pressing member. The button sensing element is installed in the mouse body. The pressing member covers an outer portion on one side of the mouse body, and a connecting pole is extended from a lower surface of the pressing member, where the connecting pole is inserted into the mouse body to abut against and connect to the button sensing element. The idle stroke eliminating part is disposed outside the mouse body and located on one side of the mouse body that is far away from the button sensing element. The idle stroke eliminating part includes a pivot and an interference member. The pivot extends from the pressing member and is pivotally connected to the mouse body, and the interference member extends from the pivot and one side of the interference member far away from the pivot is crimped on an upper surface of the mouse body, so that an idle stroke is eliminated.

Preferably, the mouse body includes an upper enclosure and a lower enclosure, and the upper enclosure interconnects with the lower enclosure, so that an installing space is formed between the upper enclosure and the lower enclosure. The button sensing element is disposed in the installing space; the pressing member covers the outside of the upper enclosure; and the connecting pole abuts against and connects to the button sensing element through the upper enclosure. The idle stroke eliminating part is disposed outside the upper enclosure; the pivot is pivotally connected to the upper enclosure; and the side of the interference member that is far away from the pivot is crimped on an upper surface of the upper enclosure. Preferably, the idle stroke eliminating part further includes a bump; the bump juts out from the upper enclosure; and the pivot is pivotally connected to the bump, so as to be pivotally connected to the upper enclosure. Preferably, the idle stroke eliminating part further includes a pivot rod. One side of the pivot rod connects to the bump; the other side of the pivot rod connects to the pivot; and the pivot is pivotally connected to the pivot rod, so as to be pivotally connected to the bump. Preferably, a pivot hole is provided on the pivot and the pivot rod connects to the pivot hole.

Preferably, the side of the interference member that is far away from the pivot includes a crimping part. The crimping part is crimped on the upper surface of the upper enclosure; and the crimping part and the upper surface of the upper enclosure are interference fit. Preferably, the idle stroke eliminating part further includes a limiting groove, and the limiting groove is provided on an outside surface of the upper enclosure. The crimping part is connected to and fixed in the limiting groove; the crimping part is crimped on a bottom surface of the limiting groove; and the crimping part and the bottom surface of the limiting groove are interference fit, so thereby avoiding the crimping part from randomly sliding on an outside surface of the middle segment.

Preferably, the interference member includes a horizontal segment and a vertical segment. The horizontal segment extends from the pivot. The vertical segment extends downward from the horizontal segment; and the crimping part horizontally extends from the vertical segment. Preferably, the horizontal segment, the vertical segment, and the crimping part form a step shape, thereby reducing a horizontal space.

Preferably, the upper enclosure comprises a front segment, a middle segment, and a rear segment. The middle segment extends from the front segment, and the rear segment extends from the middle segment, so that the middle segment is located between the front segment and the rear segment. The pressing member covers the outside of the front segment; the connecting pole connects to the button sensing element through the front segment; the idle stroke eliminating part is disposed outside the middle segment; and the limiting groove is provided on an upper surface of the middle segment. Preferably, the button sensing element is located below the front segment; at least one through hole is provided on the front segment; and the connecting pole abuts against and connects to the button sensing element through the through hole, so that it is ensured that the connecting pole can firmly abut against the button sensing element.

Preferably, the mouse body further includes an outer enclosure. The outer enclosure covers the outside of the middle segment and the rear segment in accordance with the idle stroke eliminating part; and the idle stroke eliminating part is located between the outer enclosure and the middle segment. Preferably, the middle segment and the rear segment form an L shape. Preferably, an interval space is formed between the outer enclosure and the middle segment; and the idle stroke eliminating part is located in the interval space. Preferably, the mouse body further includes a circuit board. The circuit board is installed in the installing space; and the button sensing element is fixed on the circuit board and is electrically connected to the circuit board. Preferably, the mouse body further includes a scroll wheel and an encoding element. The scroll wheel is installed on one side of the pressing member. The encoding element is installed in the installing space and is fixed on the circuit board, and the encoding element is electrically connected to the circuit board. The scroll wheel is connected to the encoding element.

### BRIEF DESCRIPTION OF THE DRAWINGS

FIG. 1 is a three-dimensional view of a mouse according to the present invention;

FIG. 2 is a partial cross-sectional view of a mouse according to the present invention;

FIG. 3 is a schematic diagram of a mouse in use according to the present invention; and

FIG. 4 is a status diagram of a mouse not in use according to the present invention.

### DETAILED DESCRIPTION OF THE PREFERRED EMBODIMENT

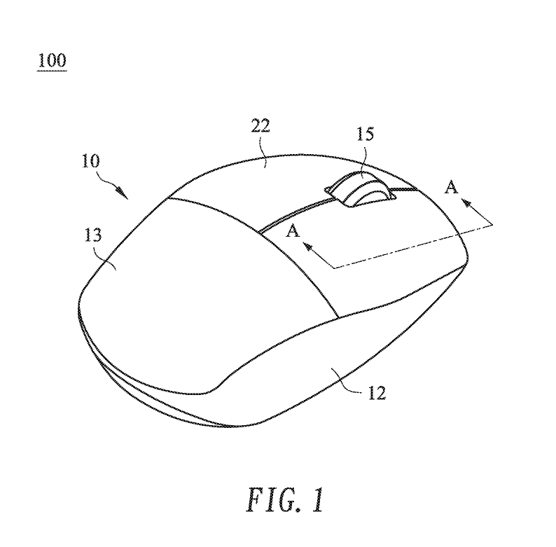

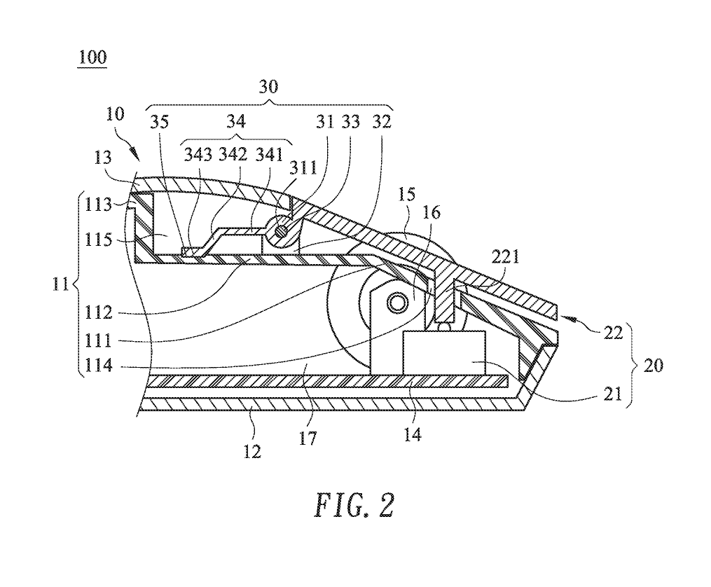

Referring to FIG. 1 and FIG. 2, a three-dimensional view and a partial cross-sectional view of a mouse according to the present invention are shown. The mouse 100 includes a mouse body 10, a button input component 20 and an idle stroke eliminating part 30 (as shown in FIG. 2).

The mouse body 10 includes an upper enclosure 11, a lower enclosure 12, an outer enclosure 13, a circuit board 14, a scroll wheel 15, and an encoding element 16. The upper enclosure 11 includes a front segment 111, a middle segment 112, and a rear segment 113. The middle segment 112 extends from one side of the front segment 111, and the rear segment 113 extends from one side of the middle segment 112 that is far away from the front segment 111, so that the middle segment 112 is located between the front segment 111 and the rear segment 113. The rear segment 113 and the middle segment 112 form an L shape. A pair of through holes 114 are provided on the front segment 111. The upper enclosure 11 interconnects with the lower enclosure 12, so that an installing space 17 is formed between upper enclosure 11 and the lower enclosure 12. The outer enclosure 13 covers the outside of the middle segment 112 and the rear segment 113, and an interval space 115 is formed between the outer enclosure 13 and the middle segment 112. The circuit board 14 and the encoding element 16 are separately installed in the installing space 17, and the encoding element 16 is fixed on the circuit board 14 and is electrically connected to the circuit board 14. The scroll wheel 15 is installed on the front segment 111 of the upper enclosure 11 and is connected to the encoding element 16. The encoding element 16 is an encoder. In addition, the mouse body 10 further includes a controller and an optical sensor. The controller and the optical sensor are separately installed on the circuit board 14 and are separately and electrically connected to the circuit board 14.

The button input component 20 includes a pair of button sensing elements 21 and a pair of pressing members 22. The pair of button sensing elements 21 are installed in the installing space 17 of the mouse body 10. Each button sensing element 21 is located below the front segment 111 and is arranged in accordance with a through hole 114. The pair of button sensing elements 21 are separately fixed on the circuit board 14 and are separately and electrically connected to the circuit board 14. Each button sensing element 21 is a button sensor. The encoding element 16 is located between the pair of button sensing elements 21. Each pressing member 22 covers the outside of the front segment 111, the scroll wheel 15 is installed between the pair of pressing members 22, and a connecting pole 221 is extended from a lower surface of each pressing member 22. Each free end of the connecting pole 221 abuts against and connects to a corresponding button sensing element 21 through a through hole 114 of the front segment 111.

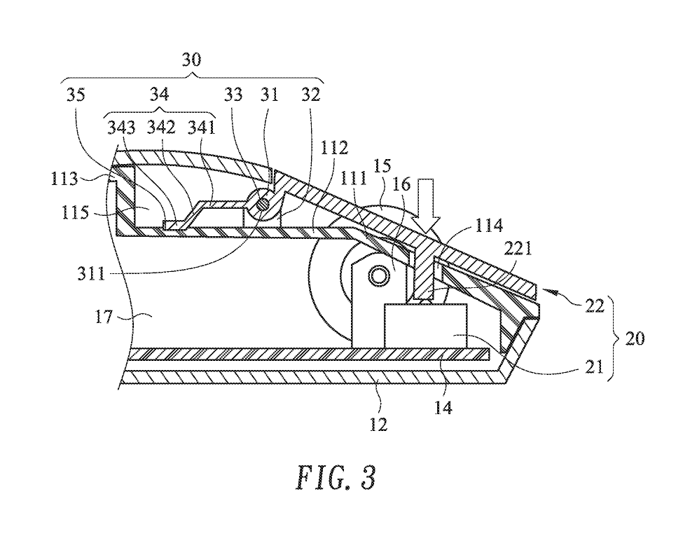

Referring to FIG. 3, FIG. 3 is a schematic diagram of a mouse in use according to the present invention. Each idle stroke eliminating part 30 is disposed outside a middle segment 112 of an upper enclosure 11; each idle stroke eliminating part 30 is located in an interval space 115, so that each idle stroke eliminating part 30 is located between an outer enclosure 13 and the middle segment 112. Each idle stroke eliminating part 30 includes a pivot 31, a bump 32, a pivot rod 33, an interference member 34, and a limiting groove 35. Each pivot 31 extends to the middle segment 112 from one end of each pressing member 22 that is far away from each connecting pole 221; a pivot hole 311 is provided on each pivot 31; and each bump 32 juts out to the outer enclosure 13 from the middle segment 112 of the upper enclosure 11. One side of each pivot rod 33 connects to the bump 32 and the other side connects to the pivot hole 311, so that each pivot 31 is pivotally connected to the pivot rod 33, so as to be pivotally connected to the bump 32, and each pivot 31 is pivotally connected to each bump 32, so as to be pivotally connected to the middle segment 112 of the upper enclosure 11. In addition, the bumps 32 may also form a protruding member by sticking to each other; and two sides of the bump each connect to one side of each pivot rod 33.

Each interference member 34 extends from one side of a pivot 31 that is far away from the pressing member 22, and one side of each interference member 34 that is far away from the pivot 31 is crimped on an upper surface of the middle segment 112. Each interference member 34 includes a horizontal segment 341, a vertical segment 342, and a crimping part 343. Each horizontal segment 341 extends from one side of the pivot 31 that is far away from each pressing member 22, and each vertical segment 342 extends downward from one side of the horizontal segment 341 that is far away from each pivot 31. Each crimping part 343 horizontally extends from each vertical segment 342 to a direction that is far away from each horizontal segment 341. Each horizontal segment 341, each vertical segment 342, each crimping part 343 form a step shape. Each limiting groove 35 is provided on an outside surface of one side of the middle segment 112 that is far away from a front segment 111, and each limiting groove 35 is beside each bump 32. Each crimping part 343 is connected to and fixed in the limiting groove 35, and each crimping part 343 and a bottom surface of each limiting groove 35 are interference fit, so that the middle segment 112 can provide an upward force F1 to each crimping part 343. Each interference member 34 is plastic or of metal materials, or the like, and this is not limited herein.

In use of the mouse, one pressing member 22 is pressed to move downward, so that the corresponding connecting pole 221 moves downward to press a corresponding button sensing element 21, and a signal is transmitted to a controller when the corresponding button sensing elements 21 is pressed by the connecting pole 221. The controller transmits the signal to, for example, a computer mainframe or a smart television, so as to operate an operating system of the computer mainframe or the smart television.

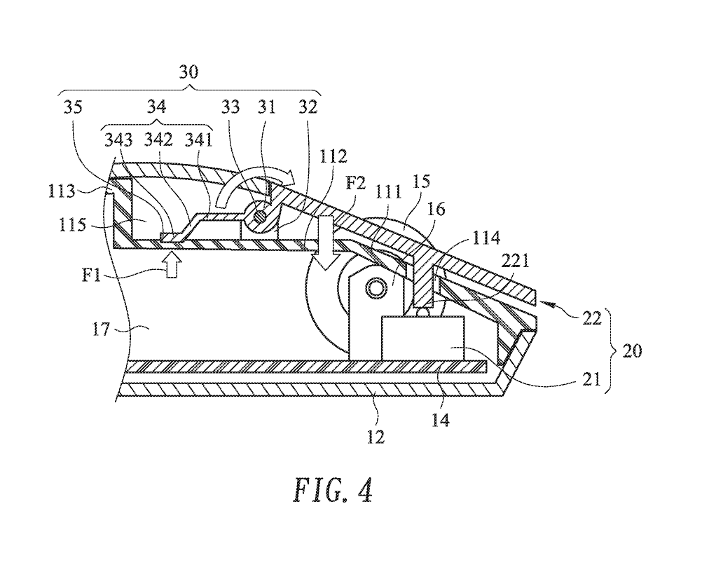

Referring to FIG. 4, FIG. 4 is a status diagram of a mouse not in use according to the present invention. Herein, each pressing member 22 may deform for factors such as its structure, combination tolerance, or process, so that a connecting pole 221 of each pressing member 22 fails to abut against and connect to a corresponding button sensing element 21, causing an idle stroke between the connecting pole 221 of each pressing member 22 and the corresponding button sensing element 21. Therefore, for a design that a middle segment 112 of an upper enclosure 11 and a crimping part 343 of each interference member 34 are interference fit, the middle segment 112 can provide one upward force F1 to each crimping part 343, so that each pivot 31 turns clockwise and provides one downward force F2 to each pressing member 22 before the pressing member 22 is pressed by fingers of a user, to force each pressing member 22 to slightly move downward and force an end of each connecting pole 221 that is away from each pressing member 22 to closely abut against and connect to the button sensing element 21, making each connecting pole 221 and each button sensing element 21 closely stick together, so that the idle stroke that is generated between each connecting pole 221 and each button sensing element 21 is eliminated.

In addition, each connecting pole 221 abuts against and connects to a corresponding button sensing element 21 through a through hole 114 that passes through a front segment 111, therefore each connecting pole 221 may be limited through the through hole 114, so as to avoid deviation of each connecting pole 221 that results in a case in which each connecting pole 221 fails to abut against the corresponding button sensing element 21; therefore, a design that the connecting pole 221 needs to pass through a through hole 114 to abut against and connect to the button sensing element 21 may be used to ensure that the connecting pole 221 can firmly abut against the button sensing element 21.

In addition, each crimping part 343 may be fixed in each limiting groove 35 to avoid a case in which the crimping part 343 and the middle segment 112 randomly slide on the surface of the middle segment 112 for the sake of interference fit, and to ensure that each interference member 34 makes each pivot 31 turn clockwise, so as to ensure that the idle stroke eliminating part 30 eliminates the idle stroke as expected.

Further, because each interference member 34 is step-shaped, each idle stroke eliminating part 30 may reduce a horizontal space that is occupied in an interval space 115, thereby reducing space.

As described above, first, a design of the idle stroke eliminating part 30 is used to eliminate the idle stroke that is generated between the connecting pole 221 and the button sensing element 21; second, a design that the connecting pole 221 needs to pass through the through hole 114 to abut against the button sensing element 21 may be used to ensure that the connecting pole 221 can firmly abut against the button sensing element 21; third, the crimping part 343 may be fixed in the limiting groove 35 to avoid a case in which the crimping part 343 randomly slides on an outside surface of the middle segment 112; forth, because that the interference member 34 is step-shaped, the idle stroke eliminating part 30 may reduce a horizontal space that is occupied in the interval space 115, thereby reducing space.

The foregoing descriptions are merely preferred embodiments of the present invention, and are not intended to limit the patent scope of the present invention. Therefore, any equivalent change or modification completed without departing from the spirit disclosed in the present invention shall fall within the patent scope of this application.

What is claimed is:

1. A mouse, comprising:
a mouse body;
a button input component, comprising:
at least one button sensing element, installed in the mouse body, and
at least one pressing member, covering an outer portion on one side of the mouse body, a connecting pole extending from a lower surface of the pressing member, and the connecting pole being inserted into the mouse body to abut against and connect to the button sensing element; and
at least one idle stroke eliminating part, disposed outside the mouse body and located on one side of the mouse body that is far away from the button sensing element; the idle stroke eliminating part comprising a pivot and an interference member; the pivot extending from the pressing member and being pivotally connected to the mouse body; and the interference member extending from the pivot, and one side of the interference member far away from the pivot being crimped on an upper surface of the mouse body.

2. The mouse according to claim 1, wherein the mouse body comprises an upper enclosure and a lower enclosure, and the upper enclosure interconnects with the lower enclosure, so that an installing space is formed between the upper enclosure and the lower enclosure; the button sensing element is disposed in the installing space; the pressing member covers the outside of the upper enclosure; the connecting pole abuts against and connects to the button sensing element through the upper enclosure; the idle stroke eliminating part is disposed outside the upper enclosure; the pivot is pivotally connected to the upper enclosure; and the side of the interference member that is far away from the pivot is crimped on an upper surface of the upper enclosure.

3. The mouse according to claim 2, wherein the idle stroke eliminating part further comprises a bump; the bump juts out from the upper enclosure; and the pivot is pivotally connected to the bump, so as to be pivotally connected to the upper enclosure.

4. The mouse according to claim 3, wherein the idle stroke eliminating part further comprises a pivot rod; one side of the pivot rod connects to the bump; the other side of the pivot rod connects to the pivot; and the pivot is pivotally connected to the pivot rod, so as to be pivotally connected to the bump.

5. The mouse according to claim 4, wherein a pivot hole is provided on the pivot and the pivot rod connects to the pivot hole.

6. The mouse according to claim 2, wherein the side of the interference member that is far away from the pivot comprises a crimping part; the crimping part is crimped on the upper surface of the upper enclosure; and the crimping part and the upper surface of the upper enclosure are interference fit.

7. The mouse according to claim 6, wherein the idle stroke eliminating part further comprises a limiting groove; the limiting groove is provided on an outside surface of the upper enclosure; the crimping part is connected to and fixed in the limiting groove; the crimping part is crimped on a bottom surface of the limiting groove; and the crimping part and the bottom surface of the limiting groove are interference fit.

8. The mouse according to claim 7, wherein the interference member comprises a horizontal segment and a vertical segment; the horizontal segment extends from the pivot; the vertical segment extends downward from the horizontal segment; and the crimping part horizontally extends from the vertical segment.

9. The mouse according to claim 8, wherein the horizontal segment, the vertical segment, and the crimping part form a step shape.

10. The mouse according to claim 7, wherein the upper enclosure comprises a front segment, a middle segment, and a rear segment; the middle segment extends from the front segment; the rear segment extends from the middle segment; the middle segment is located between the front segment and the rear segment; the pressing member covers the outside of the front segment; the connecting pole connects to the button sensing element through the front segment; the idle stroke eliminating part is disposed outside the middle segment; and the limiting groove is provided on an upper surface of the middle segment.

11. The mouse according to claim 10, wherein the button sensing element is located below the front segment; at least one through hole is provided on the front segment; and the connecting pole abuts against and connects to the button sensing element through the through hole.

12. The mouse according to claim 10, wherein the mouse body further comprises an outer enclosure; the outer enclosure covers the outside of the middle segment and the rear segment in accordance with the idle stroke eliminating part; and the idle stroke eliminating part is located between the outer enclosure and the middle segment.

13. The mouse according to claim 12, wherein the middle segment and the rear segment form an L shape.

14. The mouse according to claim 12, wherein an interval space is formed between the outer enclosure and the middle segment; and the idle stroke eliminating part is located in the interval space.

15. The mouse according to claim 2, wherein the mouse body further comprises a circuit board; the circuit board is installed in the installing space; and the button sensing element is fixed on the circuit board and is electrically connected to the circuit board.

16. The mouse according to claim 15, wherein the mouse body further comprises a scroll wheel and an encoding element; the scroll wheel is installed on one side of the pressing member; the encoding element is installed in the installing space and is fixed on the circuit board; the encoding element is electrically connected to the circuit board; and the scroll wheel is connected to the encoding element.
